(19) United States
(12) Patent Application Publication
(10) Pub. No.: US 2024/0210889 A1
(43) Pub. Date: Jun. 27, 2024

(54) SHOCK-RESISTANT PIEZOELECTRIC ROTARY MOTOR, IN PARTICULAR FOR WATCHMAKING

(71) Applicant: The Swatch Group Research and Development Ltd, Marin (CH)

(72) Inventors: Mohammad Hussein KAHROBAIYAN, Boudevilliers (CH); Yvan FERRI, St-Aubin-sauges (CH); Alexandre DIDIER, Erlach (CH); Lionel PARATTE, Marin-Epagnier (CH); Jean-Jacques BORN, Morges (CH)

(73) Assignee: The Swatch Group Research and Development Ltd, Marin (CH)

(21) Appl. No.: 18/528,864

(22) Filed: Dec. 5, 2023

(30) Foreign Application Priority Data
Dec. 23, 2022 (EP) 22216620.9

(51) Int. Cl. G04C 3/12; H02N 2/10; H02N 2/12

(52) U.S. Cl. CPC G04C 3/12; H02N 2/101; H02N 2/123

(57) ABSTRACT

A rotary piezoelectric motor, in particular for a timepiece, the motor including: a rotor configured to rotate and actuate a mechanical device, a stator configured to rotate the rotor, the stator including a piezoelectric actuator, the piezoelectric actuator including a moving element whose movement causes the rotor to rotate in a first direction, the piezoelectric actuator including only two electrically actuatable resonators, the two resonators being connected to the moving element to move it against the rotor to cause it to rotate, the two resonators being arranged relative to the moving element so as to cause the moving element to oscillate in first and second directions different from each other, each resonator including a centre of rotation, the two resonators being disposed relative to the moving element so that, around each centre of rotation, the torque resulting from all the acceleration forces being applied in the plane of each resonator is zero.

### TECHNICAL FIELD OF THE INVENTION

The invention relates to the technical field of rotary piezoelectric motors. The invention also relates to the technical field of timepieces provided with such a rotary piezoelectric motor.

### TECHNOLOGICAL BACKGROUND

The electric motors usually used in watchmaking are “Lavet” type rotary motors, which operate on electromagnetic physical principles. Such a motor generally includes a stator provided with coils and a magnetised rotor, which rotates by shifting the phase of the coils.

However, these motors have limited resistance to high magnetic fields. Above a certain magnetic field value, the motor jams. In general, they jam when the magnetic field exceeds 2 mT.

Thus, to avoid this problem, it is necessary to design motors that operate on other physical principles.

For example, there are electrostatic motors with combs, such as the one described in patent CH709512. But combs take up space, and they consume more energy than “Lavet” type motors.

Motors based on the piezoelectric effect have also been developed, for example in patent EP0587031. However, this is limited to actuating a calendar. However, its high power consumption and the risk of premature wear do not allow to drive a second hand, which generally requires the most energy.

To limit power consumption, an orbital piezoelectric motor is described in patent application EP21216102.0 filed on behalf of The Swatch Group Research and Development Ltd. In this motor, the rotor is driven by a ring-shaped moving element that orbits so as to contact the rotor, which is arranged inside the ring. To move the moving element, a piezoelectric actuator comprises a plurality of piezoelectric resonators formed by flexible, oscillating arms, the arms holding and moving the moving element, the arms including an actuatable piezoelectric material.

However, despite the great compactness of this solution, a lateral shock directly causes a force on the ring, thus disturbing the orbital movement and possibly causing a chronometric loss of the horological movement equipped with such a piezoelectric motor.

### SUMMARY OF THE INVENTION

The purpose of the present invention is to provide a rotary piezoelectric motor that can withstand high electromagnetic fields, that withstands lateral shocks, while maintaining low power consumption and reduced volume.

To this end, the invention relates to a rotary piezoelectric motor, in particular for a timepiece, the motor comprising:
a rotor configured to rotate and actuate a mechanical device,
a stator configured to rotate the rotor, the stator comprising a piezoelectric actuator,
   the piezoelectric actuator comprising a moving element whose movement causes the rotor to rotate in a first direction.

The invention is noteworthy in that the piezoelectric actuator comprises two electrically actuatable piezoelectric resonators, the two resonators being connected to the moving element to move it against the rotor to cause it to rotate, the two resonators being arranged relative to the moving element so as to cause the moving element to oscillate in first and second directions different from each other, each resonator including a centre of rotation, the two resonators being disposed relative to the moving element so that, around each centre of rotation, the torque resulting from all the acceleration forces being applied in the plane of each resonator is zero.

A stator with such a configuration can easily transmit rotational movement to the rotor using a piezoelectric actuator. The moving element can be moved into contact with the rotor to transmit movement in one direction. Thus, when the resonators oscillate, the moving element performs an orbital rotary movement to contact the rotor and transmits a force thereto to make it rotate in a first direction.

As the torque resulting from all the forces exerted on each centre of rotation is zero in the plane of each resonator, the effect of lateral shocks is greatly reduced, or even cancelled out. This avoids the risk of disturbing the orbital movement and therefore of chronometric losses in the case of a clockwork motor.

Furthermore, by having two piezoelectric resonators to produce oscillations in substantially different directions, the moving element can be moved in an orbital movement, without the need to multiply the number of resonators.

According to a particular embodiment of the invention, the first and second resonators are arranged perpendicular to each other, so that the first and second directions are substantially perpendicular. Thus, a circular orbital movement can be obtained.

According to a particular embodiment of the invention, the first and second resonators are each arranged on a different side of the moving element, the two sides preferably being adjacent.

According to a particular embodiment of the invention, the piezoelectric motor comprises a first translation table enabling the moving element to move in the first direction.

According to a particular embodiment of the invention, the piezoelectric motor comprises a second translation table enabling the moving element to move in the second direction.

According to a particular embodiment of the invention, the second translation table is arranged in series with the first translation table, the moving element being connected to the second translation table.

According to a particular embodiment of the invention, the first translation table and the second translation table are substantially perpendicular to each other.

According to a particular embodiment of the invention, a translation table is arranged on the other side of the moving element with respect to a resonator.

According to a particular embodiment of the invention, each resonator is provided with an oscillating mass actuated by a pair of flexible blades including a piezoelectric material.

According to a particular embodiment of the invention, the moving element performs an orbital movement in a second direction opposite to the first direction.

According to a particular embodiment of the invention, the moving element is always in contact with the rotor during operation of the rotary motor.

According to a particular embodiment of the invention, the movement of the moving element causes the rotor to rotate continuously.

According to a particular embodiment of the invention, the moving element is ring-shaped, the rotor being arranged inside the ring.

According to a particular embodiment of the invention, the contact between the moving element and the moving rotor is inside the ring.

According to a particular embodiment of the invention, the rotor comprises a toothed wheel, the ring including an internal toothing cooperating with an external toothing of the toothed wheel.

According to a particular embodiment of the invention, the moving element is fixed in rotation on itself.

According to a particular embodiment of the invention, the moving element is arranged around the rotor.

According to a particular embodiment of the invention, the first and second resonators are actuated with a 90° phase shift.

According to a particular embodiment of the invention, the first and second resonators are each arranged on a different side of the moving element, the two sides preferably being adjacent.

The invention also relates to a timepiece including a horological movement comprising a gear transmission configured to rotate at least one hand, and comprising such a piezoelectric motor arranged to actuate the gear transmission.

### BRIEF DESCRIPTION OF THE FIGURES

Other features and advantages will be clear from the description which follows, in an indicative and non-limiting manner, with reference to the appended drawings, wherein:

FIG. 1 schematically shows a top view of one embodiment of the rotary piezoelectric motor according to the invention when stopped, with the rotor and stator not in contact,

FIG. 2 schematically shows a top view of the embodiment of the rotary piezoelectric motor according to the invention in operation, with the rotor and stator in contact at six o'clock,

FIG. 3 schematically shows a top view of the embodiment of the rotary piezoelectric motor according to the invention in operation, with the rotor and stator in contact at nine o'clock,

FIG. 4 schematically shows a top view of the embodiment of the rotary piezoelectric motor according to the invention in operation, with the rotor and stator in contact at twelve o'clock,

FIG. 5 schematically shows a top view of the embodiment of the rotary piezoelectric motor according to the invention in operation, with the rotor and stator in contact at three o'clock, and

FIG. 6 shows a schematic top view of a resonator of the piezoelectric motor.

### DETAILED DESCRIPTION OF THE INVENTION

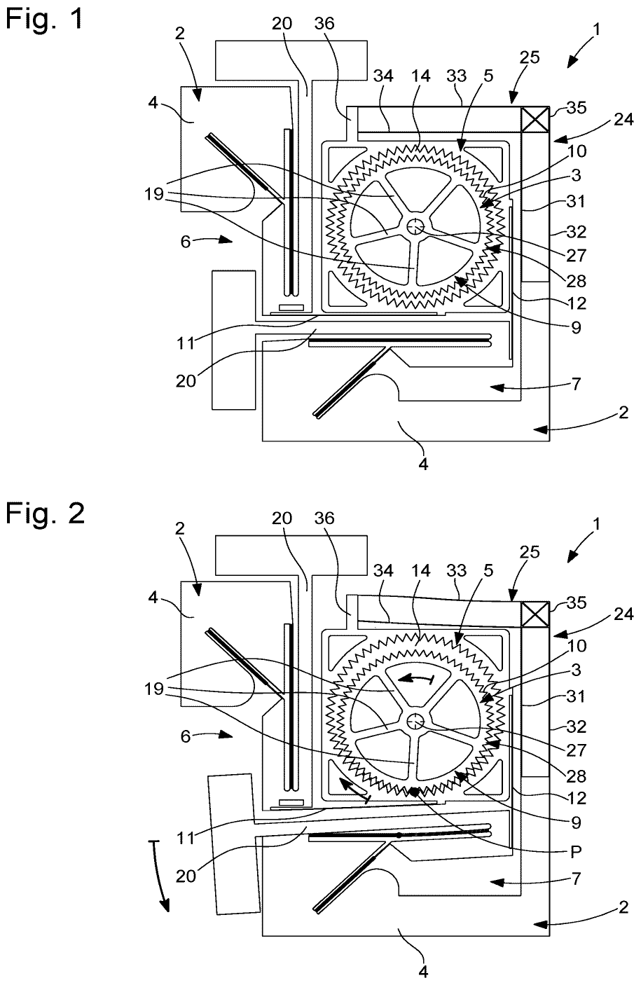

FIGS. 1 to 5 show an embodiment of a rotary piezoelectric motor 1. The piezoelectric motor 1 can be used in particular in a timepiece to actuate a display device, such as hands arranged on a dial. The piezoelectric motor 1 preferably extends substantially in one plane.

The piezoelectric motor 1 comprises a rotor 3 which can rotate on itself and is configured to be able to rotate and actuate a mechanical gear transmission, in particular for a display device. The piezoelectric motor 1 comprises a stator 2 configured to actuate and rotate the rotor 3.

The rotor 3 is, for example, a toothed wheel 9 arranged at the centre of the piezoelectric motor 1. The toothed wheel 9 is for example mounted on an axis provided with a pivot at each end, these pivots being mounted in bearings allowing the axis to rotate. The toothed wheel 9 includes an outer ring 28 and a hub 27 in the centre, the hub 27 being connected to the ring 28 by rigid spokes 19. The axis 13 includes a pinion 21 parallel to the toothed wheel 9, and arranged to transmit the movement received by the toothed wheel 9 to a gear transmission, for example to the movement of a timepiece. The rotor 3 is provided with a peripheral toothing 10 on the ring 28, which enables the toothed wheel 9 to be actuated.

Preferably, the rotor 3 and/or the stator 2 comprise a micromachinable material, such as silicon, preferably in its entirety. Alternatively, the rotor 3 may be made of metal to limit wear and friction when the stator 2 is made of silicon, and vice versa.

More alternatively, by micromachining, the rotor 3 and/or the stator 2 comprises, preferably in their entirety, a material such as quartz, nickel (obtained by metal electroplating or a LIGA-type method), diamond (obtained by ALD-type deposition) or glass (obtained by Selective Laser Etching or SLE).

The stator 2 comprises a stationary fixed element 4 and a moving element 5 configured to actuate the toothed wheel 9 of the rotor 3. The moving element 5 is arranged at a distance from the fixed element 4. The moving element 5 is in the shape of a ring with a square outer frame and a circular inner frame.

The moving element 5 is disposed around the rotor 3, the rotor 3 being arranged inside the ring. The moving element 5 is provided with an internal toothing 12 on the circular shape of the ring, the internal toothing 12 cooperating with the peripheral toothing 10 of the rotor 3 to rotate it. The ring is wider than the rotor 3 to allow the rotor 3 to be inserted, and to allow movement of the moving element 5.

As a result of the movement of the moving element 5 and its contact with the rotor 3, the rotor 3 rotates in a first direction.

To this end, the stator 2 is provided with a piezoelectric actuator.

The piezoelectric actuator comprises two electrically actuatable resonators 6, 7. A first resonator 6 and a second resonator 7 are connected to the moving element 5 so that it can be moved against the rotor 3 to rotate the latter.

The resonators 6, 7 are configured to generate an oscillatory movement, so as to guide the moving element 5 in an orbital movement. The first resonator 6 allows the moving element 5 to move in a first horizontal direction X, and the second resonator 6 allows the moving element 5 to move in a second vertical direction Y.

The first resonator 6 and the second resonator 7 each include an oscillating mass 20. Each oscillating mass 20 has a longitudinal shape extending along one side 9 of the moving element 5. Each oscillating mass 20 comprises at least one inertia-block at one end.

When a resonator 6, 7 is activated, the oscillating mass 20 pivots about a centre of rotation while oscillating.

The features and operation of the resonators 6, 7 are described in detail later in the description. Oscillations take place transversely to the side of the frame.

Each oscillating mass 20 is connected to the moving element 5 by a substantially straight secondary flexible blade 11, 12. The secondary flexible blades 11, 12 are attached to an inertia-block 21 arranged at the end of the oscillating mass 20, from a stud 22 extending from two adjacent sides of the moving element 5. The secondary flexible blades 11, 12 are substantially perpendicular to the oscillating mass 20 arms.

The secondary flexible blades 11, 12 are disposed orthogonally to each other along the two adjacent sides of the moving element 5.

When the oscillating masses 20 oscillate out of phase, each secondary flexible blade 11, 12 alternately pulls and then pushes the moving element 5.

This creates an orbital movement of the moving element 5. Orbital movement means a circular movement of the moving element 5 about an off-centre axis of rotation. In addition, the moving element 5 does not rotate on itself, as this degree of freedom is blocked by flexible translation tables as described below.

In this invention, only two resonators 6, 7 are used to create this orbital movement. It is not necessary to provide an additional resonator to obtain this movement.

To actuate the moving element 5, the first and second resonators 6, 7 oscillate in substantially orthogonal directions.

The two resonators are preferably arranged perpendicular to each other, and are disposed on two adjacent sides of the moving element 5. Thus, a substantially circular orbital movement is obtained.

To accompany and guide the movement of the moving element 5 on a third side, the moving element 5 is also connected to the stator 4 by two flexible translation tables 24, 25. A first translation table 24 and a second translation table 25 are arranged in series, the moving element 5 being attached to the second translation table 25.

Each translation table 24, 25 is equipped with two substantially parallel tertiary flexible blades 31, 32, 33, 34, and a moving rigid part 35, 36 to which the tertiary flexible blades 31, 32, 33, 34 are connected.

The tertiary flexible blades 31, 32 of the first translation table 24 are connected to the stator 2 at one end and to a first rigid part 30 at the other end.

The tertiary flexible blades 33, 34 of the second translation table 25 are connected to the first rigid part 35 at one end, and to a second rigid part 36 at the other end. The second rigid part 36 is connected to the frame of the moving element 5.

The first translation table 24 allows the moving element 5 to move with a first degree of freedom, horizontally along the axis X, and the second translation table 25 allows the moving element 5 to move with a second degree of freedom, vertically along the axis Y. Preferably, the second degree of freedom is substantially orthogonal to the first degree of freedom.

To this end, the first translation table 24 and the second translation table 25 are substantially orthogonal to each other. The two tertiary flexible blades 31, 32, 33, 34 prevent the moving element 5 from pivoting on itself, but allow lateral movement. This feature enables the moving element 5 to transmit a torque to the rotor 3 as described below.

Each translation table 24, 25 is arranged on the other side of the moving element 5 with respect to one of the resonators 6, 7. In other words, a pair formed by a resonator 6, 7 and a translation table 24, 25 is disposed on either side of the moving element 5 in the same direction, thus ensuring that the motor 1 is very compact.

The resonators 6, 7 are configured to move the moving element 5 against the rotor 3 to cause it to rotate. To this end, the resonators 6, 7 are actuated out of phase relative to each other.

The phase shift between the resonators 6, 7 generates the orbital movement, which is preferably circular, of the moving element 5. The moving element 5 performs a circular movement, while remaining fixed in rotation on itself, thanks to the two translation tables 24, 25.

The movement of the moving element 5 is preferably continuous, and causes the rotor 3 to rotate continuously. To this end, the moving element 5 is always in contact with the rotor 3 during operation of the motor. The contact point P between the moving element 5 and the rotor 3 is movable inside the ring.

FIGS. 2 to 5 show various successive instants during which the contact point P between the rotor 3 and the moving element 5 moves inside the ring, in this case in the clockwise direction. The orbital movement of the ring, whose internal space is wider than the rotor 3, generates a moving contact point P between the ring and the rotor 3. A different portion of the internal toothing 12 of the ring meshes with the peripheral toothing 10 of the toothed wheel 9 at each instant. Thus, the rotor 3 is rotated on itself in the direction opposite to P, that is to say in the counterclockwise direction.

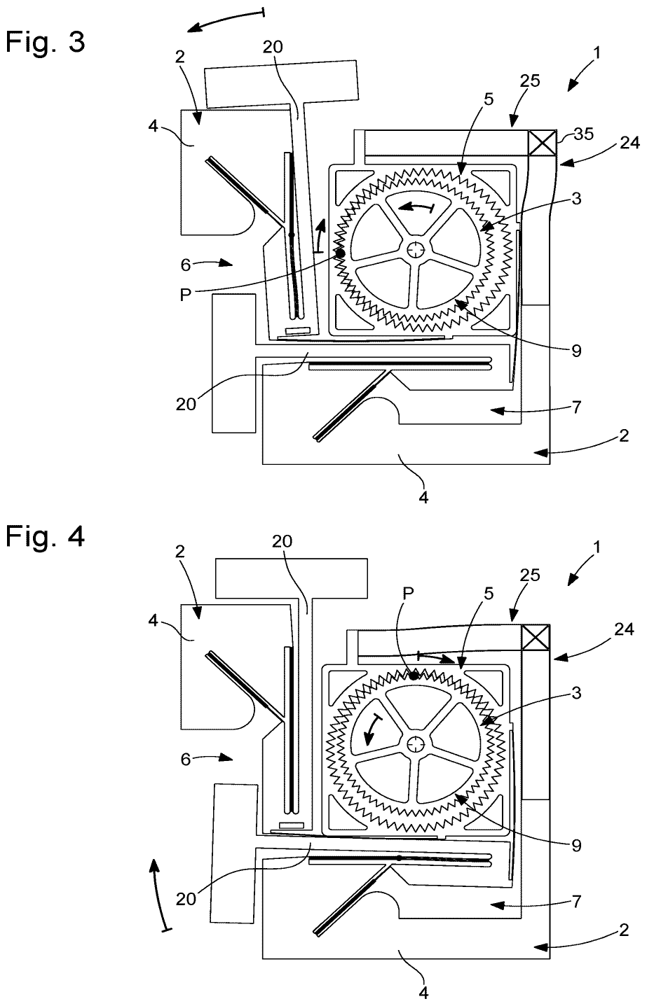

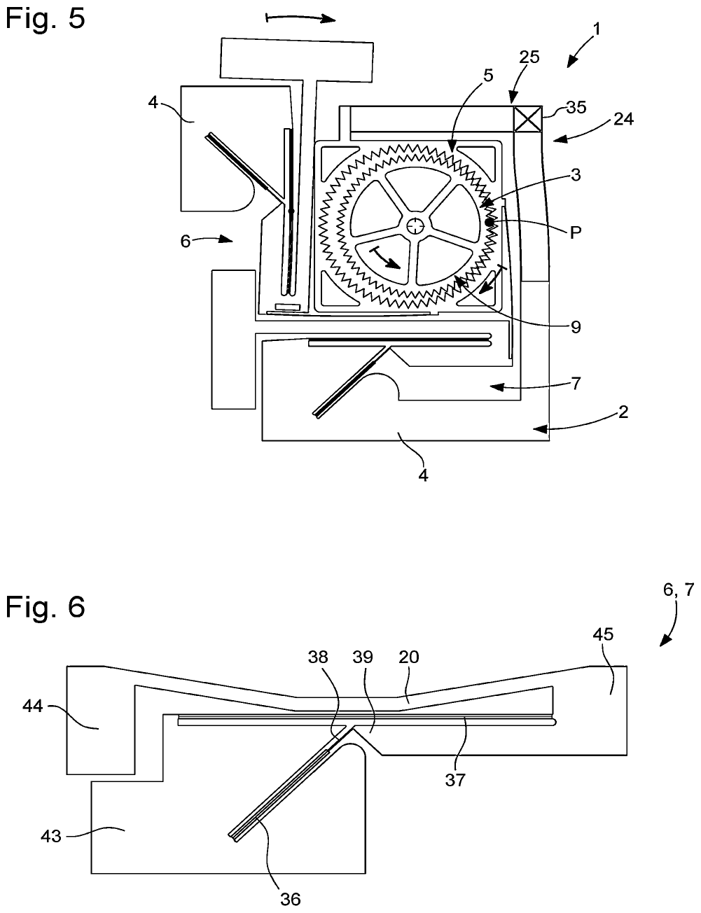

In FIG. 2, the moving element 5 is raised, so that the contact point P is at the bottom of the toothed wheel 9, that is to say at six o'clock. In FIG. 3, the moving element 5 has shifted to the right, so that the contact point P is to the left of the toothed wheel 9, that is to say at nine o'clock. Then the moving element 5 is lowered, so that the contact point P is at the top of the toothed wheel 9, that is to say at twelve o'clock, as shown in FIG. 4. Finally, in FIG. 5, the moving element 5 has shifted to the left, so that the contact point P is on the right of the toothed wheel 9, that is to say at three o'clock. From one figure to the next, the moving element 5 has made an orbital movement of a quarter turn. The secondary flexible connection blades 11, 12, the tertiary flexible blades 31, 32, 33, 34 of the two translation tables 24, 25, and the flexible blades of the resonators 6, 7 bend according to the direction wherein the moving element 5 moves. The oscillating masses 20 also follow the movement: they oscillate sinusoidally with a 90° phase shift between each of the resonators 6, 7.

The rotor 3 and the moving element 5 form what is commonly known in mechanics as a harmonic gearbox. The toothing 10 of the rotor 3 comprises 56 teeth, for example, while the toothing 12 of the moving element 5 comprises 60 teeth. The reduction factor r between the speed of the contact point and the speed of the rotor is given by

$$r = \frac{Zm - Zr}{Zr}$$

where Zm designates the number of teeth of the moving element 5, and Zr designates the number of teeth of the rotor 3. Thus, in this example,

$$r = \frac{60 - 56}{56} = \frac{1}{14} .$$

This reduction is advantageous because it is directly integrated into the motor, thus reducing the number of additional reduction gears required to drive a hand, for example.

Preferably, at least one tooth of the toothing 10 of the rotor 3 is in contact with the toothing 12 of the moving element 5 to transmit the movement. Thus, this avoids the risk of the rotor 3 jamming. The moving element 5 and the rotor 3 can be dimensioned so that only one tooth of the toothing 10 is in contact with the toothing 12 of the rotor 3.

Preferably, the amplitudes of the alternating voltages applied to the resonators 6, 7, capable of causing the moving element 5 to oscillate, are variable so as to make the oscillation of the moving element 5 perfectly circular, with the purpose of compensating for any undesired ovalisation of the trajectory, and thus also of increasing the efficiency of the motor 1.

The electrical signals applied to each of the two resonators 6, 7 are preferably sinusoidal and 90° out of phase: when one of the amplitudes is at its maximum, the other is zero, and vice versa.

If the rotor 3 is to be rotated in the other direction, the sign of the phase shift of the electrical voltages applied to the resonators 6, 7 is simply reversed. Thus, the oscillations of the oscillating masses 20 cause the moving element 5 of the stator 2 to rotate in the other direction. In the case of actuating a hand display, this allows to adjust the position of the hands in both directions.

In the case of a watch, the resonance frequency or natural frequency of each of the resonators 6, 7 of the piezoelectric motor 1 is adapted to the frequency of the quartz, which is used to regulate the rate of the movement. By operating at the resonance frequency, a reasonable amplitude is obtained for a given power consumption.

An excitation frequency is chosen that corresponds not only to the resonance frequency, but also to a sub-multiple of the quartz frequency, which is generally 32764 Hz. For example, a frequency of 128 Hz or 256 Hz is chosen. The frequency of the motor 1 is preferably adjusted and tuned to the excitation frequency so that its oscillation amplitude does not fall below 90-95% of the maximum amplitude at resonance.

The frequency is adapted by modifying the mass of the moving element 5 and/or the rigidity of the flexible blades. For example, a ring can be assembled under the moving element 5 to make it heavier so as to lower its oscillation frequency. The ring, which is not shown in the figures, comprises, for example, nickel silver, preferably in its entirety.

Micro-stitches of glue can also be added to finely lower the frequency.

The frequency can also be lowered by removing material from the elastic elements, for example using a laser or by milling, to reduce their rigidity.

To increase the frequency, the mass of the moving element 5 can be lightened by removing material, for example by laser or milling. As these methods allow very precise adjustment, they are preferably used to tune the motor to the quartz.

As the resonators 6, 7 are micromachined, small inertia-blocks can also be removed during construction to increase the frequency to a target value.

The resonance peak of the motor coupled to its load is dimensioned sufficiently large, much larger than that of the quartz. This is why it is possible to vary the speed of the motor slightly by changing its excitation frequency, without losing much amplitude, for example to make up for a loss of condition following a shock or any other disturbance, in order to realign the quartz time base with the position of the hands.

According to the invention, the two resonators 6, 7 are disposed with respect to the moving element 5, so that the torque resulting from all the acceleration forces applied in the plane of each resonator 6, 7 is zero.

This advantage is achieved by the configuration of the piezoelectric motor described above.

For example, during a sudden horizontal acceleration (along the axis X) to the right, the resonator 6, the moving element 5 and the pair of translation tables 24, 25 undergo acceleration forces which tend to push them to the left.

The resonators 6, 7 are dimensioned and arranged in relation to the moving element 5 in such a way that the torque resulting from all the forces applied around the centre of rotation of the resonator 6, 7 is zero in the plane of each resonator 6, 7.

Thus, the resonator 6, 7 can oscillate without being disturbed by a lateral shock. This is still true for other shock directions acting on this same resonator 6, 7, if the centre of mass of the resonator alone is located on a straight line passing through the pivot point.

FIG. 6 shows a resonator 6, 7, such as those used in the piezoelectric motor of FIGS. 1 to 5. The resonator 6 includes an oscillating mass 20 with a main arm, a first inertia-block 44 at a first end, and a second inertia-block 45 at a second end, the second inertia-block 45 forming an elbow folded under the main arm.

The base 43 has a parallelepiped shape offset towards the substantially straight first inertia-block 44, with a first corner facing the folded elbow of the second inertia-block 45. The base 43 is arranged between the first inertia-block 44 and the folded elbow of the second inertia-block 45. The base 43 comprises an oblique channel 38 open from the first corner towards the inside of the base 43.

The resonator comprises a flexible guide with a first flexible blade 36 connecting the oscillating mass 20 to the base 43, from the end of the folded elbow, the first flexible blade 36 extending into the oblique channel 38 to an attachment point at the bottom of the oblique channel 38.

The flexible guide comprises a second flexible blade 37 extending parallel to the arm of the oscillating mass 20, from a second corner of the base 43 to an attachment point inside the folded elbow of the oscillating mass 20. The second flexible blade 37 is arranged above the first flexible blade 36.

The first flexible blade 36 and the second flexible blade 37 form a “Y”, and extend so as to form a non-zero angle comprised between 10° and 80°, preferably between 30° and 60°, or even between 40° and 50°.

The two flexible blades 36, 37 include a piezoelectric material, disposed here entirely on the second flexible blade 37, and partly on the first flexible blade 36. The flexible blades 36, 37 are actuated in the same way as in the previous embodiments, by means of electrical contacts not shown in the figures.

For example, the flexible blades have a layer of piezoelectric material sandwiched between two layers of electrodes. The electrode layers are in turn arranged on top of a monolithic structural support material, for example monocrystalline or polycrystalline silicon, such as quartz, glass, metal, etc. . . . .

To actuate the flexible blades 36, 37, the base 43 comprises a plurality of electrical contacts 9 connected to the electrode layers to receive an electrical current and actuate the piezoelectric layers of the flexible blades.

The piezoelectric layers preferably include a crystalline or polycrystalline material, for example solid ceramic (for sodium potassium niobate) or PZT (for lead titanium zirconate) type ceramic, with the flexible blades 36, 37 having a thickness that allows them to be deformed.

Thus, by electrically activating the layers of piezoelectric material, the flexible blades 36, 37 alternately deform laterally towards the centre and outwards. The activation is produced with an alternating voltage. By actuating the piezoelectric layers, the flexible blades 36, 37 bend slightly and then straighten alternately at a predefined frequency.

By choosing to actuate the two flexible blades 36, 37 in phase opposition, the oscillating mass 20 performs small oscillations about a centre of rotation corresponding to the point where the two flexible blades cross.

Thus, the oscillating mass 20 oscillates and the two inertia-blocks 44, 45 move laterally at a certain frequency.

The resonators 6, 7 according to the methods described above, preferably mainly include a monocrystalline or polycrystalline material, such as silicon, glass, ceramic or a metal.

The resonators 6, 7 are obtained, for example, by photo-lithographic micromachining methods of the MEMS (micro-electro mechanical systems) type. The rigidity, elasticity and machining precision of such materials give resonators 6, 7 a high resonance quality.

In addition, the non-magnetic and low conductivity features of some of these materials provide excellent resistance to high DC and AC magnetic fields.

Furthermore, the resonators 6, 7 are configured to cause the oscillating mass 20 to oscillate at the natural frequency of the resonator 6, 7.

Thus, limiting the power consumption of the resonator, in particular by increasing the angular travel of the oscillating mass.

Other types of resonator are of course possible, such as RCC, double RCC or spiral type resonators. Examples of piezoelectric resonators are described in patent applications EP22216410.5, EP22216418.8 and EP22216423.8.

It will be understood that various modifications and/or improvements and/or combinations obvious to the person skilled in the art may be made to the various embodiments of the invention set out above without departing from the scope of the invention defined by the appended claims.

1. A rotary piezoelectric motor for a timepiece, the motor comprising:
a rotor configured to rotate and actuate a mechanical device,
a stator configured to rotate the rotor, the stator comprising a piezoelectric actuator,
the piezoelectric actuator comprising a moving element whose movement causes the rotor to rotate in a first direction, wherein the piezoelectric actuator comprises two electrically actuatable resonators, the resonators being connected to the moving element to move the moving element against the rotor to cause the rotor to rotate, the two resonators being arranged relative to the moving element so as to cause the moving element to oscillate in first and second directions different from each other, each resonator including a centre of rotation, the two resonators being disposed relative to the moving element so that, around each centre of rotation, the torque resulting from all the acceleration forces being applied in the plane of each resonator is zero.

2. The piezoelectric motor according to claim 1, wherein the first and second resonators are arranged perpendicular to each other, so that the first and second directions are substantially perpendicular.

3. The piezoelectric motor according to claim 1, wherein the first and second resonators are each arranged on a different side of the moving element, the two sides preferably being adjacent.

4. The piezoelectric motor according to claim 1, comprising a first translation table enabling the moving element to move in the first direction.

5. The piezoelectric motor according to claim 4, comprising a second translation table enabling the moving element to move in the second direction.

6. The piezoelectric motor according to claim 5, wherein the second translation table is arranged in series with the first translation table, the moving element being connected to the second translation table.

7. The piezoelectric motor according to claim 5, wherein the first translation table and the second translation table are substantially perpendicular to each other.

8. The piezoelectric motor according to claim 1, wherein a translation table is arranged on the other side of the moving element with respect to a resonator.

9. The piezoelectric motor according to claim 1, wherein each resonator is provided with an oscillating mass actuated by a pair of flexible blades including a piezoelectric material.

10. The piezoelectric motor according to claim 1, wherein the moving element performs an orbital movement in a second direction opposite to the first direction.

11. The piezoelectric motor according to claim 1, wherein the moving element is always in contact with the rotor during operation of the rotary motor.

12. The piezoelectric motor according to claim 10, wherein the movement of the moving element causes the rotor to rotate continuously.

13. The piezoelectric motor according to claim 1, wherein the moving element is ring-shaped, the rotor being arranged inside the ring.

14. The piezoelectric motor according to claim 13, wherein the contact between the moving element and the moving rotor is inside the ring.

15. The piezoelectric motor according to claim 13, wherein the rotor comprises a toothed wheel, the ring including an internal toothing cooperating with an external toothing of the toothed wheel.

16. The piezoelectric motor according to claim 1, wherein the moving element is fixed in rotation on itself.

17. The piezoelectric motor according claim 1, wherein the first and second resonators are actuated with a 900 phase shift.

18. A timepiece including a horological movement comprising a gear transmission configured to rotate at least one hand, wherein the timepiece comprises a piezoelectric motor according to claim 1, the piezoelectric motor being arranged to actuate the gear transmission.
